(19) United States
(12) Patent Application Publication
(10) Pub. No.: US 2015/0281276 A1
(43) Pub. Date: Oct. 1, 2015

(54) MONITORING COMPLIANCE WITH SECURITY POLICIES FOR COMPUTER NETWORKS

(71) Applicant: JUNIPER NETWORKS, INC., Sunnyvale, CA (US)

(72) Inventor: Anantha Krishnan U, Bangalore (IN)

(73) Assignee: JUNIPER NETWORKS, INC., Sunnyvale, CA (US)

(21) Appl. No.: 14/226,622

(22) Filed: Mar. 26, 2014

(51) Int. Cl. H04L 29/06

(52) U.S. Cl. CPC H04L 63/20

(57) ABSTRACT

In one example, a server device for monitoring security policy compliance for a network includes a network interface and a control unit configured to determine that a target endpoint device is attempting to access the network, send, via the network interface, instructions to a trusted endpoint device of the network to cause the trusted endpoint device to determine whether the target endpoint device complies with at least one security policy, and grant the target endpoint device access to the network when the trusted endpoint device indicates that the target endpoint device complies with the at least one security policy.

### TECHNICAL FIELD

This disclosure relates to monitoring compliance with security policies in computer networks.

### BACKGROUND

Computer networks include interconnected computerized devices that communicate with one another. In many cases, networks are formed that include a set of devices owned, operated, or maintained by a common entity, such as a business enterprise. These networks are commonly referred to as “enterprise networks.” Such enterprise networks are often isolated from public networks, such as the Internet, by security devices, such as firewalls.

Administrators may implement security policies that permit devices access to an enterprise network. Such policies may include, for example, requirements that antivirus software be installed on a device, that the antivirus software be up to date, that an operating system for the device be up to date and/or have installed a security patch, or the like.

A server device on the enterprise network may be tasked with enforcing these security policies. For instance, the server device may determine whether an endpoint device complies with the security policies. If the endpoint device complies with the security policies, the server device may grant the endpoint device access to the enterprise network. On the other hand, if the endpoint device does not comply with the security policies, the server device may deny the endpoint device access to the enterprise network.

### SUMMARY

In general, this disclosure describes techniques for monitoring compliance with security policies in computer networks. In particular, this disclosure recognizes that, with the increase in bring-your-own-device (BYOD) use, devices that monitor security compliance are becoming increasingly more heavily burdened in their tasks. As the number of BYOD devices increase, compliance determinations may become more computationally intensive and increase network traffic in certain unsecure situations in which endpoint devices may lack compliance with the security policies. That is, with increasing adoption of BYOD (e.g., in the form of smartphones, tablets, netbooks, and the like), as well as an ever-expanding list of security vulnerabilities, detailed device checking is challenging in terms of computational (CPU) power and network activity on the side of the server that monitors and enforces compliance with security policies. This causes significant performance and scalability issues with server devices that perform security compliance checks and/or enforcement.

The techniques of this disclosure may be used to alleviate some of the computational burden placed on a server device for monitoring security policy compliance and/or network traffic between the server device and endpoint devices attempting to gain access to an enterprise network. In particular, in accordance with the techniques of this disclosure, the server device that monitors security policies may offload some of the monitoring tasks to other endpoint devices of the enterprise network that have already been verified to comply with the security policies. For instance, a trusted endpoint device may execute an application that allows the server device to send a particular task and an identifier of a target endpoint device. The trusted endpoint device may execute the task on the target endpoint device, e.g., determine whether the target endpoint device is running an up-to-date version of antivirus software. For example, a server device of an enterprise network could offload 30% of CPU-intensive tasks for security compliance checks of an employee's device to a user-invisible application (controlled by the server device) that runs on a trusted endpoint device (e.g., of another employee), that was recently determined to be compliant. In this manner, the burden of monitoring compliance with security policies may be offloaded from the server device and network traffic may be distributed between endpoint devices, rather than bottlenecking at the server device.

In one example, a method includes determining, by a server device that monitors security policy compliance for a network, that a target endpoint device is attempting to access the network, sending, by the server device, instructions to a trusted endpoint device of the network to cause the trusted endpoint device to determine whether the target endpoint device complies with at least one security policy, and granting, by the security device, the target endpoint device access to the network when the trusted endpoint device indicates that the target endpoint device complies with the at least one security policy.

In another example, a method includes receiving, by an endpoint device of a network, instructions from a server device that monitors security policy compliance for the network, wherein the instructions include instructions to determine whether a target endpoint device complies with at least one security policy, in response to the instructions, determining, by the endpoint device, whether the target endpoint device complies with the at least one security policy, and sending, by the endpoint device, data indicating whether the target endpoint device complies with the at least one security policy to the server device.

In another example, a server device for monitoring security policy compliance for a network includes a network interface and a control unit configured to determine that a target endpoint device is attempting to access the network, send, via the network interface, instructions to a trusted endpoint device of the network to cause the trusted endpoint device to determine whether the target endpoint device complies with at least one security policy, and grant the target endpoint device access to the network when the trusted endpoint device indicates that the target endpoint device complies with the at least one security policy.

In another example, an endpoint device of a network includes a network interface and a control unit configured to receive, via the network interface, instructions from a server device that monitors security policy compliance for the network, wherein the instructions include instructions to determine whether a target endpoint device complies with at least one security policy, in response to the instructions, determine whether the target endpoint device complies with the at least one security policy, and send, via the network interface, data indicating whether the target endpoint device complies with the at least one security policy to the server device.

In another example, a system includes a trusted endpoint device of a network and a server device of the network, wherein the server device is configured to determine that a target endpoint device is attempting to access the network and to send instructions to the trusted endpoint device to cause the trusted endpoint device to determine whether the target endpoint device complies with at least one security policy, wherein the trusted endpoint device is configured to receive the instructions, in response to the instructions, determine whether the target endpoint device complies with the at least one security policy, and send data indicating whether the target endpoint device complies with the at least one security policy to the server device, and wherein the server device is configured to grant the target endpoint device access to the network when the trusted endpoint device indicates that the target endpoint device complies with the at least one security policy.

In another example, a computer-readable storage medium having stored thereon instructions that, when executed, cause a processor of a server device that monitors security policy compliance for a network to determine that a target endpoint device is attempting to access the network, send instructions to a trusted endpoint device of the network to cause the trusted endpoint device to determine whether the target endpoint device complies with at least one security policy, and grant the target endpoint device access to the network when the trusted endpoint device indicates that the target endpoint device complies with the at least one security policy.

In another example, a computer-readable storage medium having stored thereon instructions that, when executed, cause a processor of an endpoint device of a network to receive instructions from a server device that monitors security policy compliance for the network, wherein the instructions include instructions to determine whether a target endpoint device complies with at least one security policy, in response to the instructions, determine whether the target endpoint device complies with the at least one security policy, and send data indicating whether the target endpoint device complies with the at least one security policy to the server device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example computer network in which a security management device determines whether nodes comply with security policies for an enterprise network.

FIG. 2 is a block diagram illustrating an example configuration of components of a security management device in accordance with the techniques of this disclosure.

FIG. 3 is a block diagram illustrating an example endpoint device in accordance with the techniques of this disclosure.

FIGS. 4A and 4B are flowcharts illustrating example methods in which an endpoint device is determined to comply with security policies and then performs offloaded security policy compliance monitoring tasks on behalf of a server device in accordance with the techniques of this disclosure.

### DETAILED DESCRIPTION

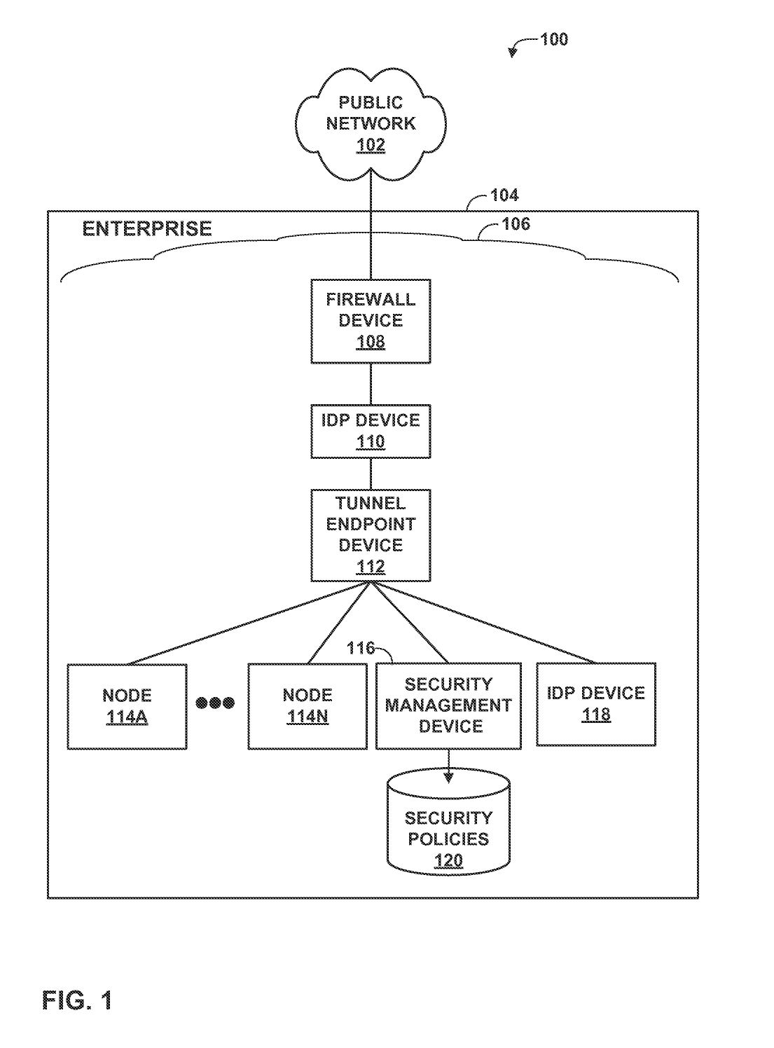

FIG. 1 is a block diagram illustrating an example computer network 104 in which security management device 116 determines whether nodes 114A-114N comply with security policies for enterprise network. In particular, FIG. 1 illustrates system 100, including computer network 104 and public network 102. Computer network 104 includes a private enterprise network 106, including firewall device 108, intrusion detection and prevention (IDP) device 110, tunnel endpoint device 112, nodes 114A-114N (nodes 114), security management device 116, and IDP device 118. In general, the techniques of this disclosure are described with respect to security management device 116. However, it should be understood that other devices of enterprise network 106 may perform the techniques of this disclosure, e.g., one or more of firewall device 108, IDP device 110, IDP device 118, tunnel endpoint device 112, or a separate server device dedicated to monitoring compliance with security policies (not shown in FIG. 1).

Nodes 114 include both devices provided by the corresponding enterprise and bring-your-own-devices (BYODs). In general, the techniques of this disclosure are directed to techniques for mitigating increases in both processing and bandwidth increases related to security compliance monitoring as, increasingly, more users bring their own devices into enterprise networks, such as enterprise network 106. For instance, it is not uncommon for a user to bring their own smart phones, tablets, laptops, and the like, to an office enterprise environment, which drastically increases the amount of processing a policy compliance device performs, as well as bandwidth allocated to network communication related to ensuring that devices on the enterprise network comply with applicable security policies.

Network 104 includes a private enterprise network 106 that is coupled to public network 102, such as the Internet. Public network 102 may include, for example, one or more client computing devices. Firewall device 108 protects private enterprise network 106 and, in particular, computing nodes 114A-114N (nodes 114). Computing nodes 114 represent any private computing device within enterprise network 106, for example, workstations, laptops, file servers, print servers, database servers, web servers, e-mail servers, databases, printers, personal digital assistants (PDAs), smart phones, tablets, and other devices. Computing nodes 114 may also be referred to as endpoint devices. Security management device 116 may manage one or more network security devices of enterprise network 106, e.g., IDP device 110, firewall device 108, IDP device 118, or one or more of computing nodes 114. In one example, security management device 116 may implement the simple network management protocol (SNMP) to modify settings of the network security devices.

In accordance with the techniques of this disclosure, in the example of FIG. 1, security management device 116 is configured with a set of security policies 120. Before an endpoint device can become connected to enterprise network 106, security management device 116 ensures that the endpoint device complies with applicable policies of security policies 120. For instance, security policies 120 may define one or more requirements for a target endpoint device, such as a requirement that the target endpoint device is running a particular version of an operating system, a requirement that the target endpoint device is executing antivirus software, and/or a requirement that the target endpoint device is not executing a known malicious application. Security policies 120 may define whitelists and/or blacklists of applications, where whitelists include allowed applications and blacklists include known malicious applications. Assuming that the endpoint device is in compliance with security policies 120, security management device 116 may grant the endpoint device access to enterprise network 106, in which case the endpoint device may join nodes 114. Accordingly, nodes 114 may also be referred to as trusted endpoint devices.

Furthermore, according to the techniques of this disclosure, security management device 116 may offload certain compliance monitoring tasks to one or more of nodes 114 (that is, trusted endpoint devices). For instance, security management device 116 may instruct one or more of nodes 114 to verify whether a target endpoint device is in compliance with one or more of security policies 120.

Assume, for instance, that a target endpoint device is attempting to connect to enterprise network 106. Security management device 116 may send instructions to node 114A to determine whether the target endpoint device is in compliance with one of security policies 120 (e.g., a requirement that the target endpoint device is executing antivirus software). Node 114A, again, represents a trusted endpoint device, in that node 114A was previously verified to be in compliance with security policies 120. Thus, node 114A may determine whether the target endpoint device is executing antivirus software, and send data back to security management device 116. Security management device 116 may then grant or deny the target endpoint device access to enterprise network 106, based at least in part on the data received from node 114A.

In some examples, security management device 116 instructs multiple trusted endpoint devices to participate in security policy compliance determinations. For instance, security management device 116 may instruct a set of nodes 114 to determine whether a target endpoint device is in compliance with the same security policy. In this manner, security management device 116 may grant access to a target endpoint device when at least one of the set of nodes 114 indicates that the target endpoint device is in compliance with the security policy or deny access when one or more of the set of nodes 114 indicates that the target endpoint device is not in compliance with the security policy. Additionally or alternatively, security management device 116 may instruct a set of nodes 114 to determine whether a target endpoint device is in compliance with different security policies, such that different ones of nodes 114 evaluate compliance with different security policies.

Nodes 114 may execute an application for the purpose of determining whether a target endpoint device is in compliance with security policies 120. One of security policies 120 may define a requirement that an endpoint device must be executing that application, or a similar application. The application may be granted permission to evaluate software being executed by the corresponding endpoint device and/or information about the endpoint device (e.g., operating system type and version). In this manner, one of nodes 114 may execute the application and send a request to a target endpoint device to determine whether the target endpoint device is executing the application, and to communicate with the application (assuming the application is being executed) to determine information about the target endpoint device.

In some examples, security management device 116 only offloads non-critical tasks to nodes 114. Likewise, security management device 116 may only offload a maximum percentage of tasks. For instance, security management device 116 may only offload a maximum of 50% of security policy compliance tasks to nodes 114. Furthermore, security management device 116 may only offload one or more tasks that will consume less than a threshold amount of resources of a node to which the tasks are offloaded. For instance, security management device 116 may only offload tasks that will consume less than 10% of the processing capacity of a processor of node 114A. Likewise, security management device 116 may take account of other elements of a node to which tasks may be offloaded, such as current processing capacity, current available amount of battery, signal strength for a wireless signal, whether the node has recently performed security policy compliance tasks, or the like.

Moreover, users of nodes 114 may be made aware of times at which their devices are to perform an offloaded security policy compliance task. For instance, nodes 114 may be configured to present an alert to users via a graphical user interface that indicates when a security policy compliance task is to be performed. In addition, the alert may allow a user to prevent the task from being processed, e.g., if the user is performing an important task on the node.

In the example of FIG. 1, enterprise network 106 further includes IDP device 110 that monitors traffic flowing between firewall device 108 and internal computing nodes 114. IDP device 110 may also integrate pattern matching with application- and protocol-specific anomaly detection to identify sophisticated attack behaviors. In one example, IDP device 110 allows the system administrator to specify attack definitions. The system administrator may specify compound attack definitions. Further details on application of attack definitions, e.g., compound attack definitions, may be found within U.S. patent application Ser. No. 11/045,572, Guruswamy et al., “Compound Attack Detection in a Computer Network,” filed Jan. 27, 2005, which is hereby incorporated by reference in its entirety.

In the example of FIG. 1, IDP device 110 is a single network device. In other examples, a device or system may perform substantially similar functions to an IDP, and may be included in another device or system. For example, any of firewall device 108, tunnel endpoint device 112, security management device 116, IDP device 118, or individual ones of nodes 114A-114N, may perform the functions described with respect to IDP device 110. In another, components of IDP device 110 may be used within an intrusion detection system (IDS).

The attack definitions may specify, for example, any combination of textual and non-textual (e.g., binary) patterns and protocol anomalies to define complex attack signatures. Moreover, IDP device 110 may associate particular signatures with protocols of certain applications. For a given communication session intercepted by IDP device 110, the IDP attempts to identify the application type and underlying protocol for the packet flows of the session in order to select one or more attack signatures to apply to the packet flows.

IDP device 110 identifies packet flows in the monitored traffic, and transparently reassembles application-layer communications from the packet flows. A set of protocol-specific decoders within the IDP device 110 analyzes the application-layer communications and identifies application-layer transactions. In general, a “transaction” refers to a bounded series of related application-layer communications between peer devices. This disclosure may also refer to a transaction as a network session. For example, a single TCP connection can be used to send (receive) multiple HyperText Transfer Protocol (HTTP) requests (responses). As one example, a single web-page comprising multiple images and links to HTML pages may be fetched using a single TCP connection. An HTTP decoder identifies each request/response within the TCP connection as a different transaction. This may be useful to prevent certain attack definitions from being applied across transaction boundaries. In one example, a transaction may be identified according to source and destination IP address, protocol, and source and destination port numbers. Other examples may identify a transaction in other ways, for example, by using media access control (MAC) addresses.

For each transaction, the corresponding decoder analyzes the application-layer communications and extracts protocol-specific elements. For example, for an FTP login transaction, the FTP decoder may extract a pattern corresponding to a user name, a name for the target device, a name for the client device, or other information. Because a single packet flow may have multiple associated applications, IDP device 110 may switch decoders “on the fly.” IDP device 110 may also modify the determination of application(s) corresponding to the packet flow as IDP device 110 inspects more packets of the packet flow, e.g., because the application has changed or because an application uses the application layer of the OSI model as a transport layer. That is, one decoder may be analyzing the packet flow, but IDP device 110 may transfer control to a different decoder in response to a change in the application.

IDP device 110 applies the attack definitions to the elements and the protocol-specific anomalies identified by the protocol decoders to detect and prevent network attacks. For example, a system administrator may specify a compound network attack that includes the protocol anomaly of repeated FTP login failure and a pattern that matches a login username of “root.” In this manner, the system administrator may combine pattern analysis with protocol anomalies to define complex attack definitions. In the event of a network attack, IDP device 110 may take one or more programmed actions, such as automatically dropping packet flows associated with the application-layer communications within which the network attack was detected.

IDP device 110 inspects packets before the packets reach tunnel endpoint device 112. IDP device 110 forwards packets in which no attack has been detected to tunnel endpoint device 112. Tunnel endpoint device 112 may comprise, for example, a router or a switch with a plurality of network interface cards (NICs) that interface with computing nodes 114, security management device 116, IDP device 118, or other network devices. For stand-alone packets, tunnel endpoint device 112 identifies the destination of the packets and forwards the packets to the destination. For outer packets encapsulating one or more sub-packets, tunnel endpoint device 112 identifies destinations corresponding to the sub-packets and forwards the sub-packets to their respective destinations. Tunnel endpoint device 112 may also act as a tunnel start point. Tunnel endpoint device 112 may implement the GRE protocol or other encapsulation protocol.

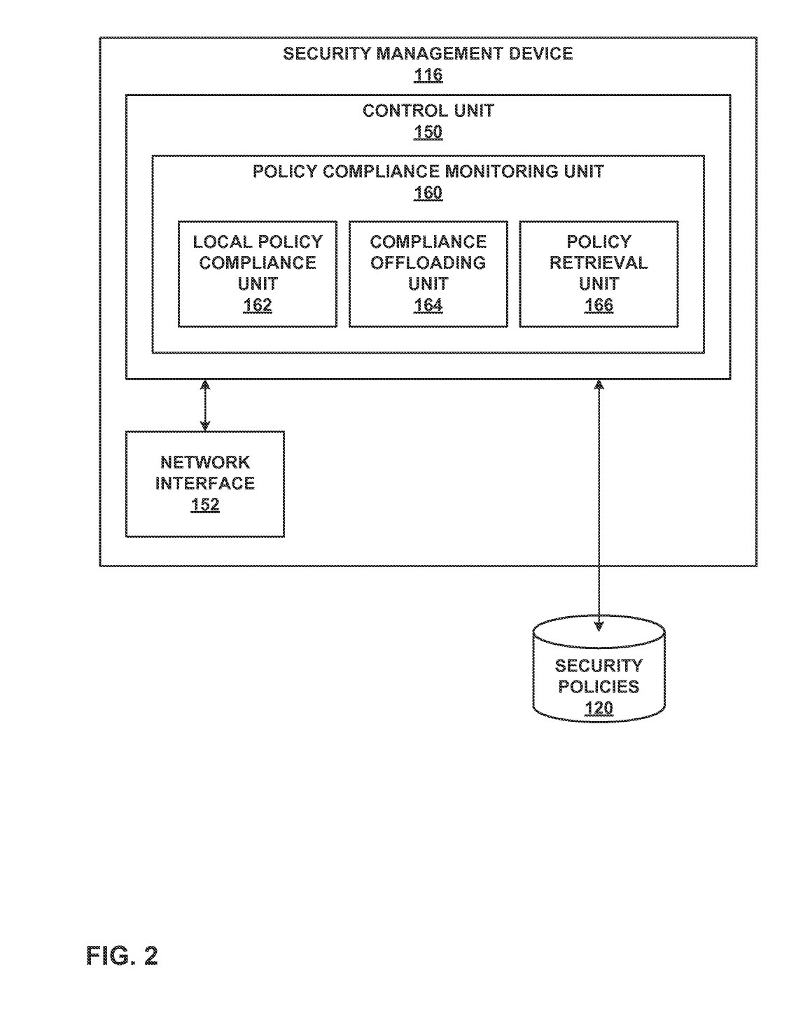

FIG. 2 is a block diagram illustrating an example configuration of components of security management device 116 in accordance with the techniques of this disclosure. In this example, security management device 116 includes control unit 150 and network interface 152. Network interface 152 may comprise one or more elements for communicating via a computer-based network, such as a network interface card (NIC) that provides Ethernet access, a wireless network interface card conforming to one or more wireless networking protocols, e.g., IEEE 802.11 protocols, or the like.

Control unit 150 may represent hardware or a combination of hardware with software and/or firmware. Thus, when including software or firmware, it should be understood that requisite hardware may be included in control unit 150, such as one or more processing units and one or more computer-readable storage media that store instructions corresponding to the software or firmware. The processing units may include any processing circuitry, such as one or more microprocessors, digital signal processors (DSPs), application-specific integrated circuits (ASICs), field programmable gate arrays (FPGAs), or the like.

In this example, control unit 150 includes (e.g., implements, executes, and/or includes as discrete units) policy compliance monitoring unit 160, which in turn includes local policy compliance unit 162, compliance offloading unit 164, and policy retrieval unit 166. Control unit 150 accesses security policies 120, e.g., to determine a policy with which one of nodes 114 is to comply. Additionally, policy retrieval unit 166 may update security policies 120, e.g., in response to receiving input from an administrator or other entity.

In general, security management device 116 may determine that an as-yet unverified one of nodes 114 (e.g., node 114B) is attempting to access enterprise network 106. In response, policy compliance monitoring unit 160 may determine whether node 114B (in this example) is in compliance with an applicable one or more of security policies 120. Assume, for purposes of example, that node 114B is a smartphone. Policy retrieval unit 166 may retrieve one or more of security policies 120 corresponding to the smartphone. For example, one or more of policies 120 may be defined for the smartphone (e.g., based on a model for the smartphone), which may indicate that an operating system for the smartphone is expected to conform to a particular version, e.g., version 4.2.0. The applicable policies may also (additionally or alternatively) indicate that the smartphone is expected to be running antivirus software. Similarly, the policies may indicate that the smartphone is expected not to be running known malicious software. Security policies 120 may define other policies as well, additionally or alternatively.

Local policy compliance unit 162 may determine whether node 114B is in compliance with one or more of the retrieved security policies. However, in accordance with the techniques of this disclosure, compliance offloading unit 164 may offload compliance checking tasks to previously checked devices, such as node 114A, assuming that node 114A was previously verified to be in compliance with security policies 120. In particular, compliance offloading unit 164 may send instructions to node 114A (representing a trusted endpoint device, in this example) to cause node 114A to determine whether node 114B (a target endpoint device, in this example) complies with at least one security policy.

For example, compliance offloading unit 164 may offload a compliance monitoring task to node 114A of determining whether an operating system of node 114B is up to date. In response to this task, node 114A may request data from node 114B indicative of a version for an operating system of node 114B. Node 114A may then compare the version for the operating system of node 114B to the version required by the policy and send information back to security management device 116 representative of whether node 114B is in compliance with the policy. Alternatively, node 114A may simply return data indicative of the current version of the operating system of node 114B to security management device 116B, and local policy compliance unit 162 may compare the version of the operating system of node 114B to the version required by the policy.

Assuming that policy compliance monitoring unit 160 determines that node 114B complies with each of the one or more relevant security policies 120 (as indicated, at least in part, by data received from node 114A in this example), security management device 116 may grant node 114B access to the network. Thus, when node 114A (a trusted endpoint device, in this example) indicates that node 114B (a target endpoint device, in this example) complies with at least one of security policies 120, policy compliance monitoring unit 160 may (assuming that node 114B complies with other applicable security policies) grant node 114B access to enterprise network 106.

Although only one trusted endpoint device is discussed above, it should be understood that compliance offloading unit 164 may offload security policy compliance monitoring tasks to a plurality of different trusted endpoint devices, e.g., a plurality of nodes 114 that are determined to comply with security policies 120. In some examples, compliance offloading unit 164 may offload compliance monitoring tasks to a plurality of nodes 114. For instance, compliance offloading unit 164 may offload different tasks to different ones of nodes 114 that are trusted (that is, determined to comply with security policies 120). Additionally or alternatively, compliance offloading unit 164 may offload the same task to different ones of nodes 114.

When offloading tasks to one of a plurality of trusted endpoint devices (e.g., one of nodes 114), compliance offloading unit 164 may select one or more of nodes 114 randomly or semi-randomly. For instance, compliance offloading unit 164 may attempt to select one or more of nodes 114 that has not recently performed a compliance monitoring task, such as those of nodes 114 that have been recently verified. Likewise, compliance offloading unit 164 may avoid overloading any one of nodes 114, e.g., by monitoring a current processing load of one or more of nodes 114 and/or avoiding offloading tasks that would exceed a certain percentage of the processing power of one of nodes 114. In this manner, compliance offloading unit 164 may formulate instructions that cause a trusted one of nodes 114 that utilize no more than a threshold amount of a processor of the trusted one of nodes 114. Furthermore, the instructions may cause the trusted one of nodes 114 to display an alert to a user of the node, and may further allow the user to override performing the instructions.

By offloading such tasks to previously verified nodes, security management device 116 may reduce a processing load placed on control unit 150. Additionally, offloading such compliance tasks may reduce bandwidth consumption related to security policy compliance monitoring between security management device 116 and nodes 114. That is, in the example above, node 114A communicates with node 114B to determine a version of the operating system, rather than node 114B sending such data directly to security management device 116. These techniques may therefore drastically reduce processing and bandwidth consumption related to security policy compliance monitoring, especially as the number of nodes 114 increases.

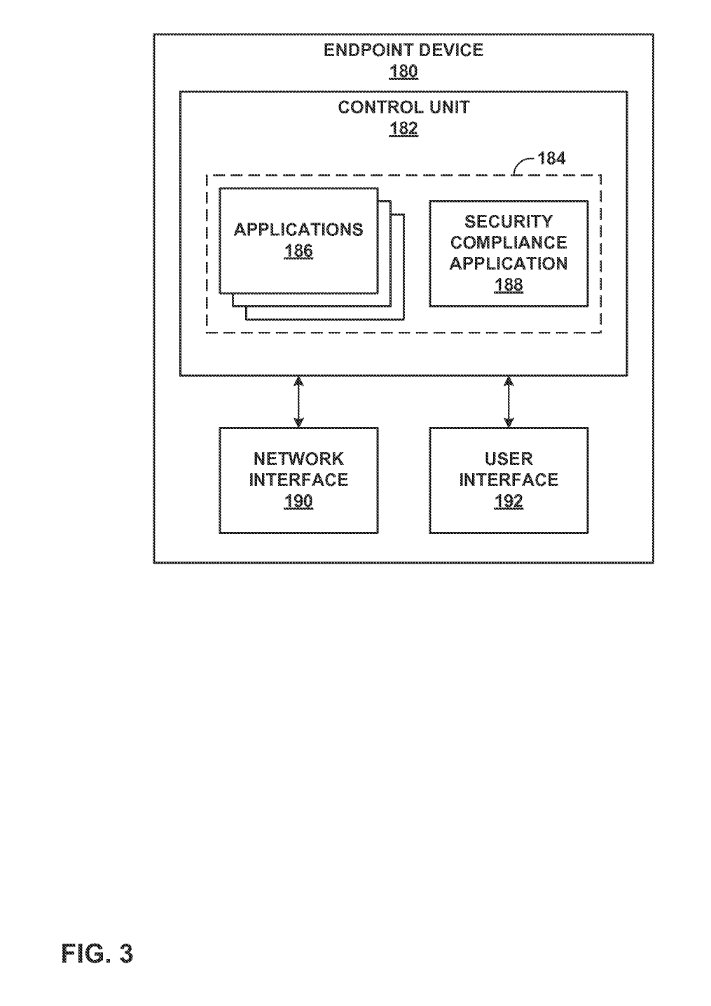

FIG. 3 is a block diagram illustrating an example endpoint device 180 in accordance with the techniques of this disclosure. Endpoint device 180 may correspond to one of nodes 114 of FIG. 1. Any or all of nodes 114 may include components similar to those of endpoint device 180. In the example of FIG. 3, endpoint device 180 includes control unit 182, network interface 190, and user interface 192. Network interface 190 may comprise one or more elements for communicating via a computer-based network, such as a network interface card (NIC) that provides Ethernet access, a wireless network interface card conforming to one or more wireless networking protocols, e.g., IEEE 802.11 protocols, or the like.

User interface 192 represents one or more user interfaces for providing output to and/or receiving input from a user. For instance, user interface 192 may comprise a screen, a touchscreen, a physical keyboard, a pointing device such as a mouse or trackpad, speakers, a microphone, a camera, accelerometers, hard keys, or the like.

Control unit 182 may represent hardware or a combination of hardware with software and/or firmware. Thus, when including software or firmware, it should be understood that requisite hardware may be included in control unit 182, such as one or more processing units and one or more computer-readable storage media that store instructions corresponding to the software or firmware. The processing units may include any processing circuitry, such as one or more microprocessors, digital signal processors (DSPs), application-specific integrated circuits (ASICs), field programmable gate arrays (FPGAs), or the like.

Control unit 182 is configured to execute a set of applications 184, which may be stored in a computer-readable storage medium of control unit 182 and executed by a processing unit of control unit 182. The set of applications 184 includes applications 186 and security compliance application 188. Applications 186 may comprise any of a variety of applications for endpoint device 180, such as email applications, web browsers, calendars, games, music players, texting applications, or the like. In accordance with the techniques of this disclosure, control unit 182 also executes security compliance application 188.

Security compliance application 188 may retrieve information from endpoint device 180 for responding to requests from other trusted endpoint devices and/or from security management device 116. For instance, security compliance application 188 may determine a type and version of an operating system (not shown in FIG. 3) for endpoint device 180, whether one of applications 186 is an antivirus application and whether the antivirus application is up to date, whether control unit 182 is executing known malicious software, or other information for endpoint device 180. Security compliance application 188 may send such information to a device that requests the information, assuming the device is either a trusted endpoint device of enterprise network 106 or security management device 116.

Furthermore, in accordance with the techniques of this disclosure, security compliance application 188 may receive instructions (via network interface 190) from security management device 116 that cause security compliance application 188, after endpoint device 180 has been verified (i.e., is trusted), to request information from other endpoint devices, e.g., other nodes 114. For example, security compliance application 188 may request information from an untrusted endpoint device indicative of an operating system of the untrusted endpoint device, a version of the operating system, whether the untrusted endpoint device is executing an antivirus application, whether the antivirus application is up to date, or the like. After receiving this information (e.g., via network interface 190), security compliance application 188 may either determine whether the untrusted endpoint device complies with an applicable policy, or forward the information to security management device 116 (or another trusted endpoint device) via network interface 190, so that security management device 116 can ultimately verify the untrusted endpoint device (that is, determine whether the untrusted endpoint device complies with applicable security policies and should become trusted).

In some examples, after receiving instructions to determine whether an untrusted endpoint device is in compliance with a security policy, but before performing the instructions, security compliance application 188 may display an alert to a user via user interface 192. The alert may request permission from the user to perform the security compliance task associated with the instructions, or simply indicate to the user that the task is being performed. When the alert requests the user's permission, security compliance application 188 may await input from the user via user interface 192 indicating the user's permission before proceeding to perform the task.

In some examples, security compliance application 188 may receive instructions from security management device 116 (or a trusted endpoint device) for a plurality of security policy compliance monitoring tasks that are to be offloaded to a plurality of other trusted endpoint devices. Thus, security compliance application 188 may send instructions to the trusted endpoint devices, to cause the trusted endpoint devices to determine whether a target endpoint device is in compliance with one or more security policies. After receiving responses from the trusted endpoint devices, security compliance application 188 may aggregate the responses to determine whether the target endpoint device is compliant with one or more applicable security policies, and forward information indicative of the determination to security management device 116.

Security compliance application 188 may also provide information to security management device 116 representative of whether endpoint device 180 should be assigned a security policy compliance monitoring task. For example, security compliance application 188 may provide information indicative of a current load for control unit 182, e.g., how much processing control unit 182 is currently capable of performing. Security management device 116 may use such information to determine whether the utilization of a processor of control unit 182 exceeds a threshold, and if so, avoid offloading a security policy compliance monitoring task to endpoint device 180. Additionally or alternatively, security compliance application 188 may send information indicative of how recently security compliance application 188 performed an offloaded security policy compliance monitoring task. Security management device 116 may use this information to determine trusted endpoint devices that have not recently performed offloaded security policy compliance monitoring tasks, in order to avoid overburdening certain trusted endpoint devices with too many tasks.

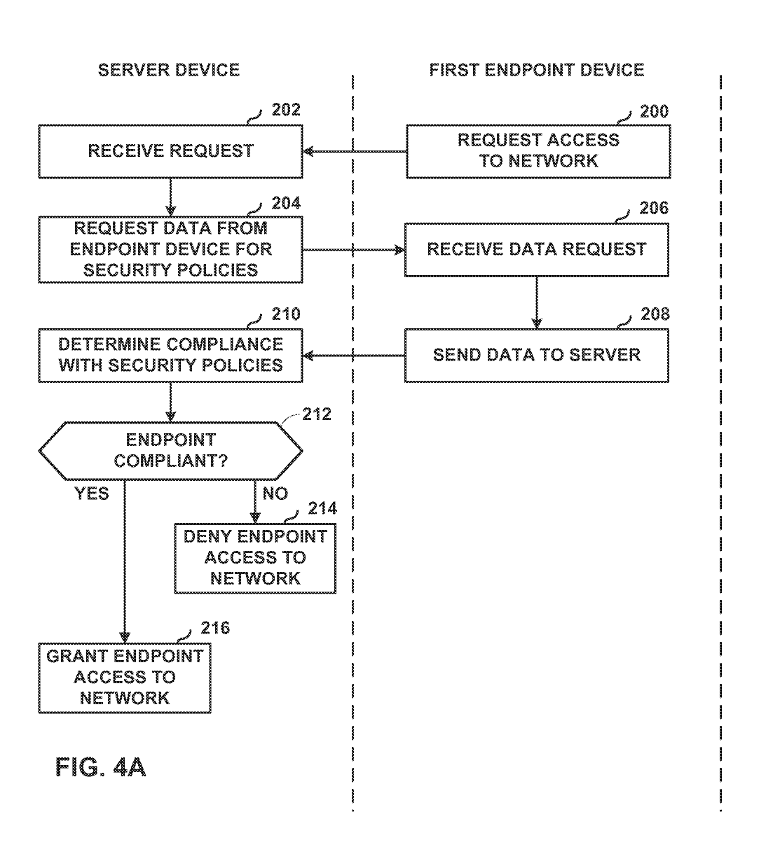

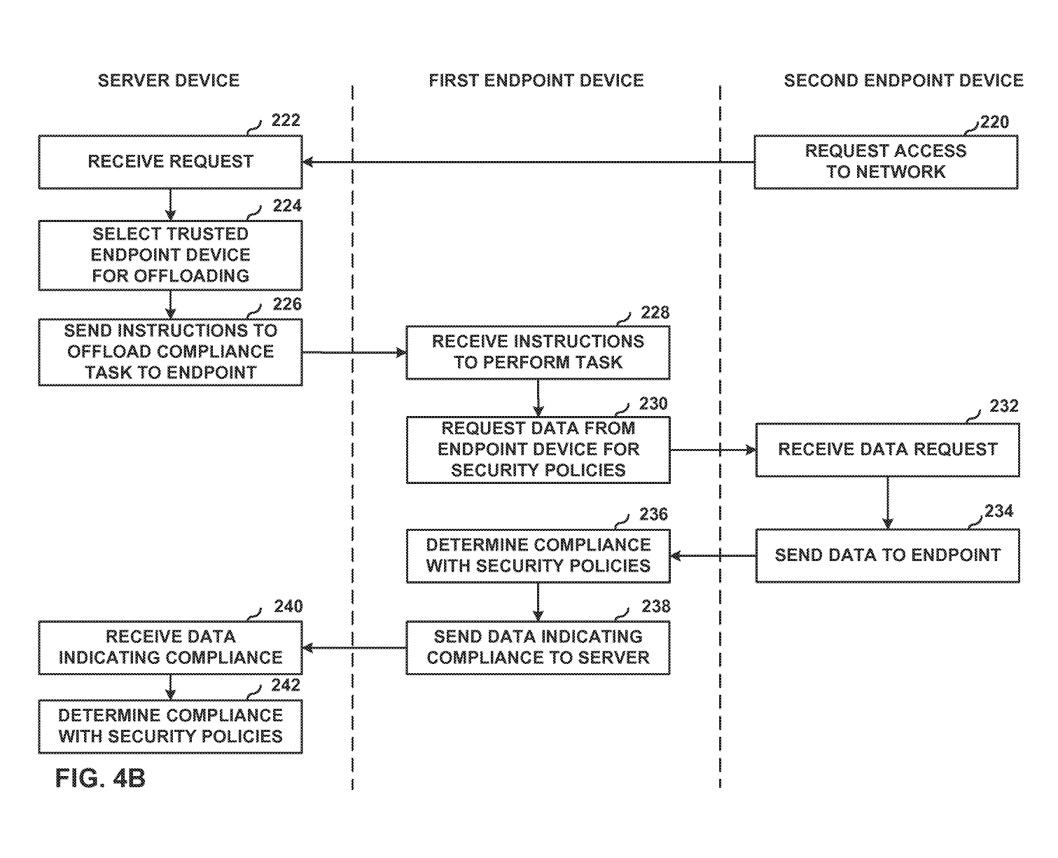

FIGS. 4A and 4B are flowcharts illustrating example methods in which an endpoint device is determined to comply with security policies and then performs offloaded security policy compliance monitoring tasks on behalf of a server device in accordance with the techniques of this disclosure. The methods of FIGS. 4A and 4B are explained with respect to a server device (which may correspond to security management device 116), a first endpoint device (e.g., node 114A), and a second endpoint device (e.g., node 114B). The server device may include components similar to those shown in FIG. 2, while the first and second endpoint devices may include components similar to those shown in FIG. 3.

Initially, in FIG. 4A, a first endpoint device (e.g., node 114A of FIG. 1) requests access to a private network, e.g., enterprise network 106 (200). A server device (e.g., security management device 116) receives the request from node 114A (202) and requests data from node 114A for applicable security policies (204). In some examples, the request may include certain information regarding node 114A, e.g., a type of device for node 114A, a model of the type of device for node 114A, or the like. Alternatively, security management device 116 may initially request such data from node 114A, and based on this data, determine applicable security policies for node 114A. Security management device 116 may then determine data to be retrieved from node 114A regarding the applicable security policies.

Node 114A may receive the data request (206) and send the requested data to security management device 116 (208). For example, security management device 116 may request a type of operating system for node 114A, a version of the operating system, whether any of a set of applications that are known to be malicious are installed on node 114A, whether node 114A is executing antivirus software, whether node 114A is executing a security compliance application (such as security compliance application 188 of FIG. 3), or the like. From this data, security management device 116 may determine whether node 114A is in compliance with the applicable security policies (210, 212). In the case that node 114A is not compliant (“NO” branch of 212), security management device 116 may deny node 114A access to enterprise network 106 (214).

Alternatively, in the case that node 114A is compliant (“YES” branch of 212), security management device 116 may grant node 114A access to enterprise network 106 (216). As such, security management device 116 may treat node 114A as a trusted endpoint device. In particular, security management device 116 may add node 114A to a pool of trusted endpoint devices from which security management device 116 may select a trusted endpoint device to which to offload a security policy compliance monitoring task, as discussed with respect to FIG. 4B. Although not shown in FIG. 4A, when verifying whether node 114A is in compliance with the applicable security policies, security management device 116 may offload one or more security policy compliance monitoring tasks to other trusted endpoint devices, e.g., according to the method explained below with respect to FIG. 4B.

In FIG. 4B, it is assumed that node 114A (representing a first endpoint device) has been verified as being compliant with applicable security policies, e.g., as explained with respect to FIG. 4A. Subsequently, a second endpoint device (e.g., node 114B) requests access to enterprise network 106 (220). Security management device 116 receives the request (222). In response to receiving the request, security management device selects one or more trusted endpoint devices to which to offload security policy compliance monitoring tasks (224). For example, security management device 116 may select node 114A randomly from a pool of trusted endpoint devices. In this example, it is assumed that node 114A (the first endpoint device) is selected. In other examples, security management device 116 may offload the same task to multiple trusted endpoint devices and/or different tasks to multiple trusted endpoint devices.

As explained above with respect to FIG. 4A, although not illustrated in FIG. 4B, security management device 116 may further determine applicable security policies for node 114B, e.g., based on a type and model of device for node 114B. Thus, security management device 116 may determine one or more tasks to be performed to determine whether node 114B is in compliance with the applicable security policies. Security management device 116 may send instructions to node 114A (a trusted endpoint device, per the assumptions stated above) to offload a security policy compliance monitoring task to node 114A (226). For example, the task may be to determine whether an operating system for node 114B is up to date, whether node 114B is executing antivirus software, whether the antivirus software is up to date, whether node 114B is executing an application that is known to be malicious, whether node 114B is executing a security compliance application such as security compliance application 188 (FIG. 3), or the like. In some examples, security management device 116 only offloads non-critical tasks.

Node 114A receives the instructions to perform the security policy compliance monitoring task from security management device 116 (228). Although not shown in FIG. 4B, node 114A may first present an alert to a user, which may request the user's permission to perform the task, before performing the task. When determining whether node 114B is compliant, node 114A may act as a proxy to security management device 116. In the example of FIG. 4B, node 114A requests data from node 114B for one or more applicable security policies (230), in a manner that may be substantially similar to step 204 of FIG. 4A, except that step 230 is performed by node 114A instead of security management device 116.

After receiving the request (232), node 114B may send the requested data to node 114A (234). After receiving the data, node 114A, in this example, determines whether node 114B is in compliance with one or more of the applicable security policies (236). Node 114A then sends data indicating whether node 114B is compliant with the applicable security policies to security management device 116 (238).

Security management device 116 receives the data indicating whether node 114B is compliant with the applicable security policies (240) and uses this data when determining whether node 114B is in compliance with these or other security policies (242). For example, server management device 116 may receive responses from a plurality of trusted endpoint devices for the same and/or different compliance monitoring tasks. Thus, although node 114A may indicate that node 114B is in compliance with one or more applicable security policies, security management device 116 may nevertheless determine that node 114B is not compliant with a different security policy. That is, security management device 116 may offload a first task to node 114A, a second task to another trusted endpoint device, and determine whether to grant node 114B access to enterprise network 106 based at least in part on data received for the first task from node 114A and the second task from the other trusted endpoint device.

In cases where a plurality of trusted network devices perform the same offloaded task, security management device 116 may determine that node 114B is compliant when at least one of the trusted network devices determines that node 114B is compliant with a security policy corresponding to the task. Alternatively, security management device 116 may determine that node 114B is compliant when, of the trusted network devices that respond to the task, none of the trusted network devices indicates that node 114B is not compliant with the security policy corresponding to the task. In yet another example, security management device 116 may determine that node 114B is compliant when, of the trusted network devices that respond to the task, each of the trusted network devices indicates that node 114B is compliant.

In this manner, FIGS. 4A and 4B represent an example of a method including determining, by a server device (e.g., security management device 116) that monitors security policy compliance for a network, that a target endpoint device (e.g., node 114B) is attempting to access the network, sending, by the server device, instructions to a trusted endpoint device (e.g., node 114A) of the network to cause the trusted endpoint device to determine whether the target endpoint device complies with at least one security policy, and granting, by the security device, the target endpoint device access to the network when the trusted endpoint device indicates that the target endpoint device complies with the at least one security policy.

Likewise, FIGS. 4A and 4B represent an example of a method including receiving, by an endpoint device (e.g., node 114A) of a network, instructions from a server device (e.g., security management device 116) that monitors security policy compliance for the network, wherein the instructions include instructions to determine whether a target endpoint device (e.g., node 114B) complies with at least one security policy, determining, by the endpoint device, whether the target endpoint device complies with the at least one security policy, and sending, by the endpoint device, data indicating whether the target endpoint device complies with the at least one security policy to the server device.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

Various examples have been described. These and other examples are within the scope of the following claims.

What is claimed is:

1. A method comprising:
determining, by a server device that monitors security policy compliance for a network, that a target endpoint device is attempting to access the network;
sending, by the server device, instructions to a trusted endpoint device of the network to cause the trusted endpoint device to determine whether the target endpoint device complies with at least one security policy; and
granting, by the security device, the target endpoint device access to the network when the trusted endpoint device indicates that the target endpoint device complies with the at least one security policy.

2. The method of claim 1, wherein sending the instructions comprises sending the instructions to a plurality of trusted endpoint devices.

3. The method of claim 2, wherein granting comprises granting the target endpoint device access to the network when at least one of the trusted endpoint devices indicates that the target endpoint device complies with the at least one security policy.

4. The method of claim 2, wherein granting comprises granting the target endpoint device access to the network when none of the trusted endpoint devices indicates that the target endpoint device does not comply with the at least one security policy.

5. The method of claim 2, further comprising randomly selecting the plurality of trusted endpoint devices from a set of available trusted endpoint devices of the network.

6. The method of claim 1, wherein the at least one security policy defines at least one requirement for the target endpoint device, wherein the at least one requirement comprises at least one of a requirement that the target endpoint device run a particular version of an operating system, a requirement that the target endpoint device is executing antivirus software, or a requirement that the target endpoint device is not executing a known malicious application.

7. The method of claim 1, wherein sending the instructions comprises offloading a non-critical task to the trusted endpoint device.

8. The method of claim 1, wherein sending the instructions comprises sending instructions formulated to utilize no more than a threshold amount of a processor of the trusted endpoint device.

9. The method of claim 1, further comprising sending instructions to the trusted endpoint device that cause the trusted endpoint device to alert a user of the trusted endpoint device that the trusted endpoint device is being used to determine whether the target endpoint device complies with the at least one security policy.

10. The method of claim 1, further comprising denying the target endpoint device access to the network when the trusted endpoint device indicates that the target endpoint device does not comply with the at least one security policy.

11. The method of claim 1, wherein the at least one security policy comprises a first security policy, the method further comprising:
determining, by the server device, whether the target endpoint device complies with a second security policy, different than the first security policy.

12. The method of claim 11, further comprising denying the target endpoint device access to the network when the trusted endpoint device indicates that the target endpoint device complies with the first security policy and when the target endpoint device does not comply with the second security policy.

13. A method comprising:
receiving, by an endpoint device of a network, instructions from a server device that monitors security policy compliance for the network, wherein the instructions include instructions to determine whether a target endpoint device complies with at least one security policy;
in response to the instructions, determining, by the endpoint device, whether the target endpoint device complies with the at least one security policy; and
sending, by the endpoint device, data indicating whether the target endpoint device complies with the at least one security policy to the server device.

14. The method of claim 13,
wherein determining whether the target endpoint device complies comprises:
sending instructions to a plurality of trusted endpoint devices, wherein the instructions include instructions to determine whether the target endpoint device complies with the at least one security policy; and
aggregating determinations from the plurality of trusted endpoint devices, and
wherein sending the data comprises sending the aggregated determinations to the server device.

15. The method of claim 13, wherein the at least one security policy defines at least one requirement for the target endpoint device, wherein the at least one requirement comprises at least one of a requirement that the target endpoint device run a particular version of an operating system, a requirement that the target endpoint device is executing antivirus software, or a requirement that the target endpoint device is not executing a known malicious application.

16. The method of claim 13, further comprising alerting a user of the endpoint device that the endpoint device is being used to determine whether the target endpoint device complies with the at least one security policy.

17. The method of claim 13, wherein determining comprises utilizing at most a threshold amount of a processor of the endpoint device to determine whether the target endpoint device complies with the at least one security policy.

18. A server device for monitoring security policy compliance for a network, the server device comprising:
a network interface; and
a control unit configured to determine that a target endpoint device is attempting to access the network, send, via the network interface, instructions to a trusted endpoint device of the network to cause the trusted endpoint device to determine whether the target endpoint device complies with at least one security policy, and grant the target endpoint device access to the network when the trusted endpoint device indicates that the target endpoint device complies with the at least one security policy.

19. The server device of claim 18, wherein the control unit is configured to send the instructions to a plurality of trusted endpoint devices.

20. The server device of claim 19, wherein the control unit is configured to grant the target endpoint device access to the network when at least one of the trusted endpoint devices indicates that the target endpoint device complies with the at least one security policy.

21. The server device of claim 19, wherein the control unit is configured to grant the target endpoint device access to the network when none of the trusted endpoint devices indicates that the target endpoint device does not comply with the at least one security policy.

22. The server device of claim 19, wherein the control unit is configured to randomly select the plurality of trusted endpoint devices from a set of available trusted endpoint devices of the network.

23. The server device of claim 18, wherein the at least one security policy defines at least one requirement for the target endpoint device, wherein the at least one requirement comprises at least one of a requirement that the target endpoint device run a particular version of an operating system, a requirement that the target endpoint device is executing antivirus software, or a requirement that the target endpoint device is not executing a known malicious application.

24. The server device of claim 18, wherein the control unit is configured to deny the target endpoint device access to the network when the trusted endpoint device indicates that the target endpoint device does not comply with the at least one security policy.

25. The server device of claim 18, wherein the at least one security policy comprises a first security policy, and wherein the control unit is configured to determine whether the target endpoint device complies with a second security policy, different than the first security policy, and to deny the target endpoint device access to the network when the trusted endpoint device indicates that the target endpoint device complies with the first security policy and when the target endpoint device does not comply with the second security policy.

26. An endpoint device of a network, the endpoint device comprising:
a network interface; and
a control unit configured to receive, via the network interface, instructions from a server device that monitors security policy compliance for the network, wherein the instructions include instructions to determine whether a target endpoint device complies with at least one security policy, in response to the instructions, determine whether the target endpoint device complies with the at least one security policy, and send, via the network interface, data indicating whether the target endpoint device complies with the at least one security policy to the server device.

27. The endpoint device of claim 26, wherein to determine whether the target endpoint device complies, the control unit is configured to send instructions to a plurality of trusted endpoint devices, wherein the instructions include instructions to determine whether the target endpoint device complies with the at least one security policy, to aggregate determinations from the plurality of trusted endpoint devices, and to send the aggregated determinations to the server device.

28. The endpoint device of claim 26, wherein the at least one security policy defines at least one requirement for the target endpoint device, wherein the at least one requirement comprises at least one of a requirement that the target endpoint device run a particular version of an operating system, a requirement that the target endpoint device is executing antivirus software, or a requirement that the target endpoint device is not executing a known malicious application.

29. A system comprising:
a trusted endpoint device of a network; and
a server device of the network, wherein the server device is configured to determine that a target endpoint device is attempting to access the network and to send instructions to the trusted endpoint device to cause the trusted endpoint device to determine whether the target endpoint device complies with at least one security policy,
wherein the trusted endpoint device is configured to receive the instructions, in response to the instructions, determine whether the target endpoint device complies with the at least one security policy, and send data indicating whether the target endpoint device complies with the at least one security policy to the server device, and
wherein the server device is configured to grant the target endpoint device access to the network when the trusted endpoint device indicates that the target endpoint device complies with the at least one security policy.

30. A computer-readable storage medium having stored thereon instructions that, when executed, cause a processor of a server device that monitors security policy compliance for a network to:
determine that a target endpoint device is attempting to access the network;
send instructions to a trusted endpoint device of the network to cause the trusted endpoint device to determine whether the target endpoint device complies with at least one security policy; and
grant the target endpoint device access to the network when the trusted endpoint device indicates that the target endpoint device complies with the at least one security policy.

31. A computer-readable storage medium having stored thereon instructions that, when executed, cause a processor of an endpoint device of a network to:
receive instructions from a server device that monitors security policy compliance for the network, wherein the instructions include instructions to determine whether a target endpoint device complies with at least one security policy;
in response to the instructions, determine whether the target endpoint device complies with the at least one security policy; and
send data indicating whether the target endpoint device complies with the at least one security policy to the server device.
